(19) United States
(12) Patent Application Publication
(10) Pub. No.: US 2024/0053050 A1
(43) Pub. Date: Feb. 15, 2024

(54) FLEXIBLE DUCT WITH SCRIM-BONDED INSULATION

(71) Applicant: Daikin Comfort Technologies Manufacturing, L.P., Waller, TX (US)

(72) Inventors: Stanley J. Rusek, JR., The Woodlands, TX (US); Darrin L. Affeldt, Katy, TX (US)

(73) Assignee: Daikin Comfort Technologies Manufacturing, L.P., Waller, TX (US)

(21) Appl. No.: 17/887,116

(22) Filed: Aug. 12, 2022

(51) Int. Cl. F24F 13/02

(52) U.S. Cl. CPC F24F 13/0263; F24F 13/0218; F24F 13/0245; F24F 13/0281

(57) ABSTRACT

A flame penetration resistant flexible duct and related devices and methods are disclosed. The flexible duct can include a tubular core, a vapor barrier, and an insulation assembly. The tubular core is configured to convey a fluid. The vapor barrier surrounds the tubular core. The insulation assembly is positioned between the tubular core and the vapor barrier. Further, the insulation assembly can include an insulation layer and a scrim layer bonded to the insulation layer. The scrim layer is configured to resist flame penetration of the flexible duct.

### BACKGROUND

Heating, ventilation, and air conditioning (“HVAC”) systems often utilize flexible duct to carry treated air throughout a structure. For example, flexible duct can be used to carry heated or cooled air to various locations within a residential home or a commercial building. However, if a fire occurs within the residential home or commercial building, the flexible duct can potentially provide a passage for flames to travel. Accordingly, flexible duct is often subjected to various fire safety-related tests to ensure that flames cannot enter the flexible duct and accelerate the spread of the fire across the various locations of a home or commercial building.

One type of fire safety-related test that flexible duct may be subjected to is a flame penetration test. Generally, flame penetration tests are designed to measure a flexible duct's ability to resist being penetrated when exposed to a flame. This is typically performed by obtaining a rectangular-shaped sample of the tubular body of the flexible duct, pacing a weight on a top surface of sample, and directing a flame towards a bottom surface of sample. In order to pass the flame penetration test, neither the weight nor the flame can penetrate the top and bottom surfaces of the sample over a predetermined period of time. Thus, designing a flexible duct to withstand a flame penetration test may ensure that the flexible duct will not accelerate the spread of fire throughout a structure. Accordingly, there is a need for flexible duct and flexible duct components that are able to resist flame penetration.

### BRIEF DESCRIPTION OF THE DRAWINGS

Embodiments of flexible duct, scrim-bonded insulation, and related methods are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates a perspective view a flexible duct;

FIG. 2 illustrates a perspective view of a portion of a flexible duct being subjected to a flame penetration test;

FIG. 3 illustrates a partial cut-away perspective view of a flexible duct with a vapor barrier that includes a scrim layer;

FIG. 4 illustrates a partial cut-away perspective view of a flexible duct with a tubular core that includes a wire structure;

FIG. 5 illustrates a partial cut-away perspective view of a flexible duct with a scrim-bonded insulation assembly, wherein the scrim layer of the scrim-bonded insulation assembly is adjacent to the vapor barrier;

FIG. 6 illustrates a partial cut-away perspective view of a flexible duct with a scrim-bonded insulation assembly, wherein the scrim layer of the scrim-bonded insulation assembly is adjacent to the tubular core;

FIGS. 7A-7C illustrate perspective views of various scrim layers;

FIGS. 8A-8C illustrate perspective views of various scrim-bonded insulation assemblies;

FIG. 9 illustrates a partial cut-away perspective view of a flexible duct with a scrim-bonded insulation assembly, wherein a first scrim layer is included in the scrim-bonded insulation assembly and a second scrim layer is included in the vapor barrier;

FIG. 10 illustrates a partial cut-away perspective view of a flexible duct with a scrim-bonded insulation assembly; and

FIG. 11 illustrates a apparatus for assembling a flexible duct that includes a scrim-bonded insulation assembly.

### DETAILED DESCRIPTION

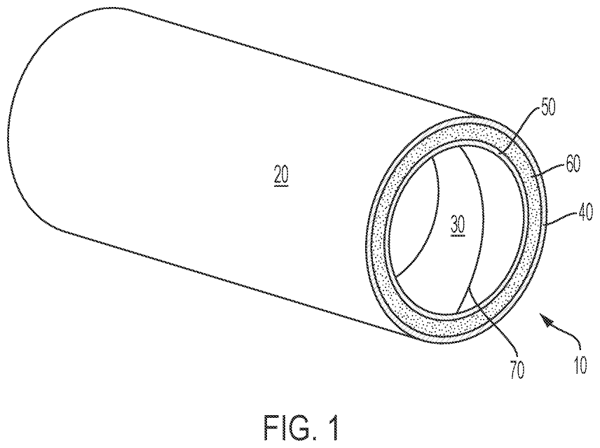

FIG. 1 illustrates a perspective view of a flexible duct 10 for use in heating, ventilation, and air conditioning (“HVAC”) systems to carry a fluid, e.g., air, as it flows through the HVAC system. To carry air, the flexible duct 10 includes a tubular-shaped body 20 with a central cavity 30 through which the air flows. Typically, the air flowing within the central cavity 30 is at a different temperature than the environment surrounding the flexible duct 10. As such, the body 20 may include three layers to prevent the air from leaking out of the central cavity 30 and to reduce thermal interactions between the air in the central cavity 30 and the surrounding environment. The resistance to the transfer of heat across the flexible duct 10 due to the temperature differential is typically referred to as the R value of the flexible duct 10. Flexible ducts 10 typically have an R value of R-4.2, R-6.0, R-8.0, R-12.0, or R-13.0, where the higher R values correspond to a higher resistance to heat transfer.

The body 20 includes a vapor barrier 40, an insulation layer 60, and a tubular core 50. The vapor barrier 40 is the radially outer layer and may be a tubular sheet that fluidly isolates the other layers from the surrounding environment. The tubular core 50 is the radially inner layer and includes a structural support 70 within a tubular sheet. The tubular core 50 fluidly isolates the other layers from the central cavity 30. The insulation layer 60 is disposed between the vapor barrier 40 and the tubular core 50 and reduces thermal interaction, and thus a rate of heat transfer, between air in the central cavity 30 and the surrounding environment.

Moisture may collect on the outer surface of the flexible duct 10 due to condensation caused by the temperature difference between the central cavity 30 and the surrounding environment. The insulation layer 60 also includes a fibrous material, such as glass fibers, which may absorb and trap moisture. In some cases, the insulation layer 60 may be constructed from a fiberglass insulation material, such as various fiberglass insulation materials known in the art. Moisture absorbed by the insulation layer 60 reduces the insulating effects of the insulation layer 60, thereby allowing more heat transfer between the central cavity 30 and the surrounding environment. Further, moisture may decrease the lifespan of the insulation layer 60. Therefore, the fluid barrier provided by the vapor barrier 40 and the tubular core 50 blocks fluids, particularly the moisture from condensation, from contacting and damaging the insulation layer 60.

When placed within an HVAC system, the flexible duct 10 may be positioned to change directions along its axial length. For example, the flexible duct 10 may be bent to carry air around corners and/or obstacles. The structural support 70 of the tubular core 50 may provide structural rigidity to the flexible duct 10 to maintain the cross-sectional area of the central cavity while also maintaining the flexibility of the flexible duct 10. The structural support 70, for example, may be a solid, such as a metal, wound into an elongated spring within the tubular sheet. Maintaining a cross-sectional area of the central cavity 30 may provide a more consistent flow path with fewer pressure variations along the length of the flexible duct 10.

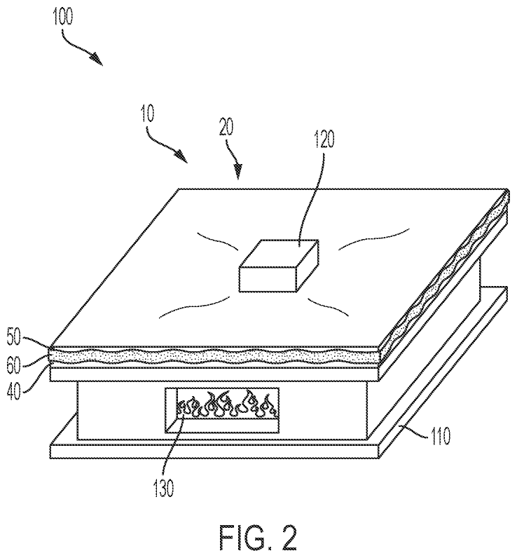

FIG. 2 illustrates a perspective view of a testing arrangement 100 being used to perform a flame penetration test on a portion of the flexible duct 10. As mentioned above, if a fire occurs within a structure in which the HVAC system and the flexible duct 10 is installed, the central cavity 30 (not shown in FIG. 2) of the flexible duct 10 may provide a passage for flames to travel throughout the structure. The flame penetration test is configured to measure the ability of the body 20 of the flexible duct 10 to resist being penetrated when exposed to a flame. Thus, designing the duct 10 to successfully withstand the flame penetration test may reduce the likelihood that the flexible duct 10 will accelerate the spread of a fire throughout a structure.

To perform the flame penetration test using the testing arrangement 100, a portion of the body 20 of the flexible duct 10 is spread as a sheet across and secured to a testing frame 110 with the vapor barrier 40 facing toward a flame 130 and the tubular core 50 facing away from the flame 130. A weight 120 may be applied to the tubular core 50 while the flame 130 is applied to the vapor barrier 40. To successfully pass the flame penetration test, neither the weight 120 nor the flame 130 can penetrate through the body 20 for a predetermined period of time.

In some aspects of the present disclosure, the testing arrangement 100 can be configured according to the UL 181 flame penetration test standard. The UL 181 standard was developed by Underwriter's Laboratories, Inc. for testing the ability of air ducts to resist flame penetration. According to the UL 181 standard, the weight 120 is a 3.6 kg weight that covers an area of 2.5 cm×10.2 cm of the tubular core 50. Further, the flame 130 is applied to the vapor barrier 40 at a temperature of about 774° C. According to the UL 181 standard, the flame penetration test is failed if either the weight 120 falls through the body 20 or the flame 130 passes through the body 20 within 30 minutes. In other aspects, the testing arrangement 100 can be configured to perform a flame penetration test according to parameters that are different from the UL 181 standard.

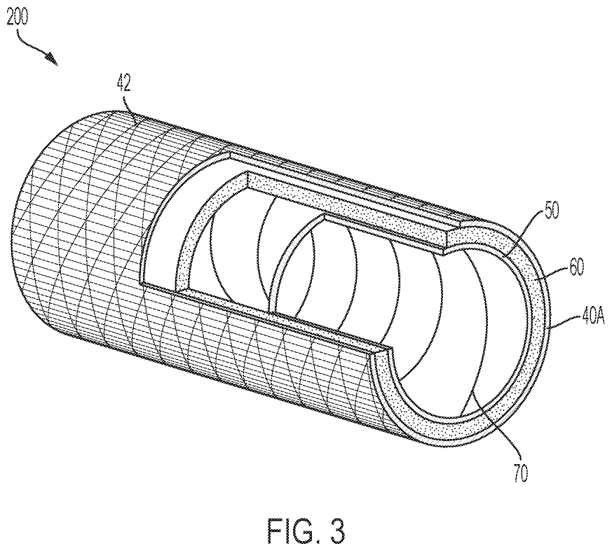

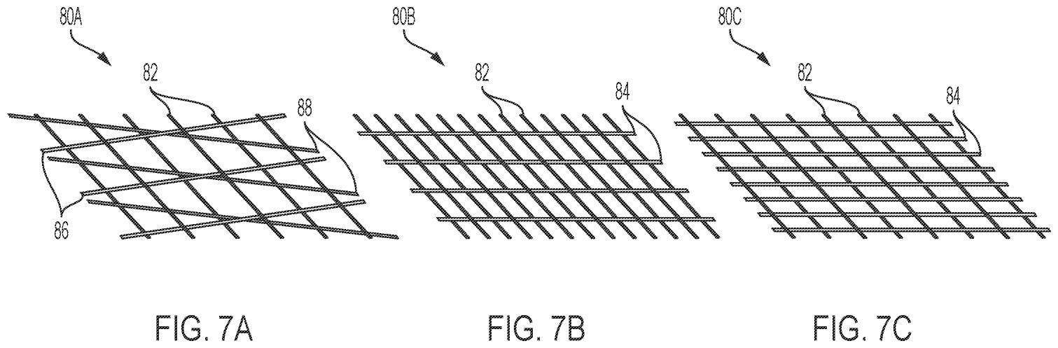

FIG. 3 illustrates a partial cut-away perspective view of a flexible duct 200 configured to resist flame penetration. The flexible duct 200 may be similar to the flexible duct 10 described above with respect to FIG. 1. For example, the flexible duct 200 includes a structural support 70, a tubular core 50, an insulation layer 60, and a vapor barrier 40A. As shown, the vapor barrier 40A includes a scrim layer 42 configured to provide structural support to the flexible duct 200. The structural support provided by the scrim layer 42 may improve the performance of the flexible duct 200 by providing additional structure to support weight, such as the weight 120. In this manner, the scrim layer 42 may improve performance of the flexible duct 200 when subjected to a flame penetration test compared to a flexible duct that does not include the scrim layer 42, for example. The scrim layer 42 may be similar in construction to the scrim layer 80 described below. For example, the scrim layer 42 may be constructed from an E-glass yarn configured in a tri-axial pattern, similar to the tri-axial pattern of the scrim layer 80A depicted in FIG. 7A.

The scrim layer 42 may be integrated into the vapor barrier 40A by being laminated between two layers of polymer film. For example, the vapor barrier 40A may include the scrim layer 42 positioned between a radially inward layer of polyester film and a radially outward layer of metallized polyester film. The metallized polyester film may provide the flexible duct 200 with a metallic appearance. Further, in some aspects, the vapor barrier 40A may be helically wound into a tubular shape using a layered sheet of scrim and laminated film components. That is, the layered sheet may be helically wound into a tubular shape with a desired circumference (e.g., greater than 6 inches) to form the vapor barrier 40A. Thus, the assembled vapor barrier 40A may have continuous, helical seam(s) where the layered sheet(s) are joined together. Accordingly, there may be interruptions in the scrim layer 42 around the circumference of the vapor barrier 40A where the seam(s) are located. In some cases, the layered sheet may have a width shorter than the outer circumference of the assembled vapor barrier 40A. The radially inward layer of polyester film, the scrim layer 42, and the radially outward layer of metallized polyester film described above may be laminated into a layered sheet having a width of about 6 inches (15.24 cm).

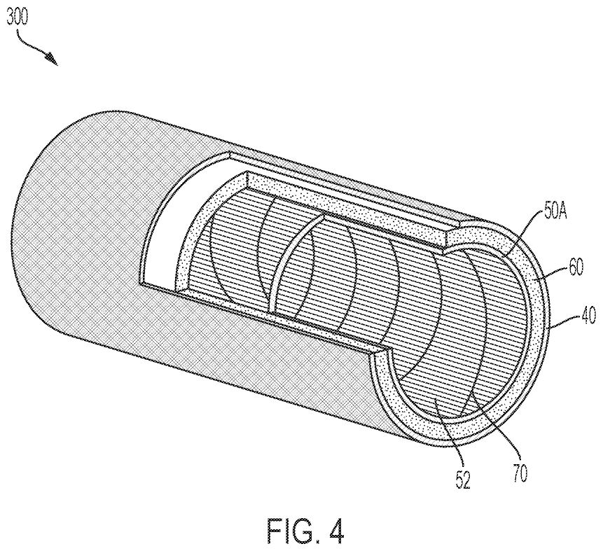

FIG. 4 illustrates a partial cut-away perspective view of a flexible duct 300 configured to resist flame penetration. The flexible duct 300 may be similar to the flexible duct 10 described above with respect to FIG. 1. For example, the flexible duct 300 includes a structural support 70, a tubular core 50A, an insulation layer 60, and a vapor barrier 40. As shown, the tubular core 50A includes a wire structure 52 in addition to the structural support 70. For example, the wire structure 52 may be an array of fine wires that extend between the helical structural support 70 to provide additional structural support to the flexible duct 300. The structural support provided by the wire structure 52 may improve the performance of the flexible duct 300 by providing additional structure to support weight, such as the weight 120 applied during a flame penetration test. In this manner, the wire structure 52 may improve performance of the flexible duct 300 when subjected to a flame penetration test compared to a flexible duct that does not include the wire structure 52, for example.

In some aspects of the present disclosure, the wire structure 52 may provide enough structural support to the flexible duct 300 that a scrim layer (e.g., the scrim layer 42 described above) need not be included in the vapor barrier 40 for the flexible duct 300 to adequately resist flame penetration. For example, the vapor barrier 40 may be constructed from a blown polyethylene film that does not include a scrim layer.

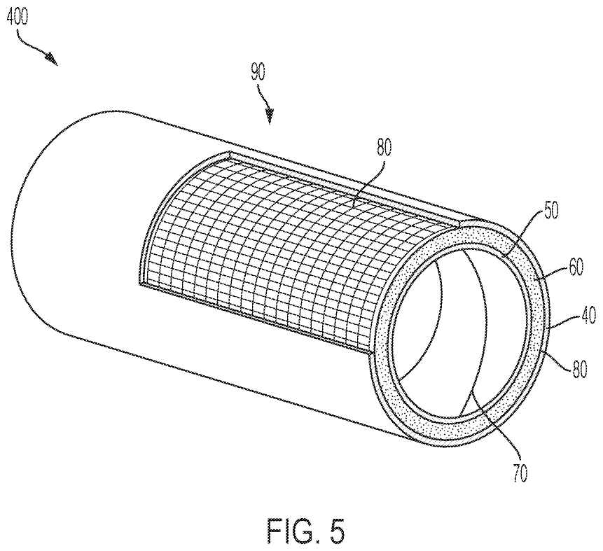

FIG. 5 illustrates a partial cut-away perspective view of a flexible duct 400 configured to resist flame penetration. The flexible duct 400 may be similar to any of the flexible ducts 10, 200, and 300 described above. For example, the flexible duct 400 includes a structural support 70, a tubular core 50, and a vapor barrier 40. However, the flexible duct 400 also includes an insulation assembly 90 that includes an insulation layer 60 and a scrim layer 80 bonded to a radially outer surface of the insulation layer 60. By including the scrim layer 80, the insulation assembly 90 provides structural support to improve the performance of the flexible duct 400 by providing additional structure to support weight, such as the weight 120. In this manner, the insulation assembly 90 may improve performance of the flexible duct 400 when subjected to a flame penetration test compared to a flexible duct that does not include the insulation assembly 90 with the scrim layer 80, for example. As shown, the insulation assembly 90 is positioned such that the scrim layer 80 is adjacent to the vapor barrier 40.

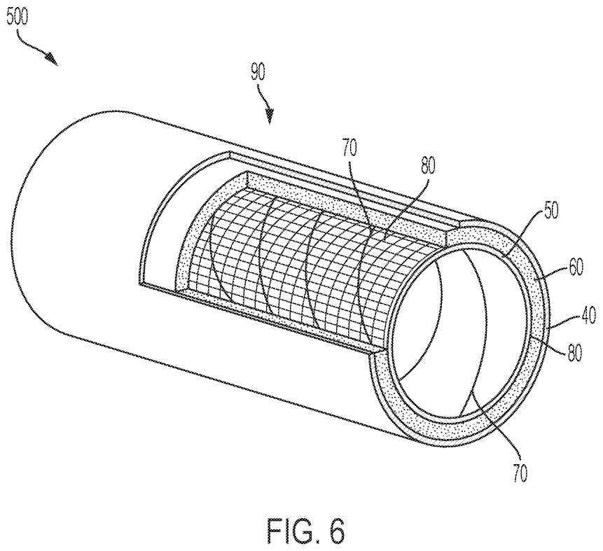

FIG. 6 illustrates a flexible duct 500 that is similar to the flexible duct 400 of FIG. 5 except that the scrim layer 80 is bonded to a radially inward surface of the insulation assembly 90. In this aspect, the scrim layer 80 is adjacent to the tubular core 50.

The scrim layer 80 may be constructed using a variety of yarn and coating materials, strand configurations, and mesh patterns. For example, the scrim layer 80 may be constructed from glass fiber textile yarn. The glass fiber textile yarn may be formed by drawing molten glass through small holes to form hair-like filaments. After the filaments cool and harden, the filaments may be gathered into strands, plied together, and/or twisted to form the glass fiber textile yarn. In some aspects, the filaments may be bound together and/or coated with various resinous and/or elastomeric binder materials such as, for example, polyvinyl alcohol, polyvinyl acetate, and/or acrylic binders to form the glass fiber textile yarn. The glass fiber textile yarn may be laid or woven into various mesh patterns. Advantageously, the yarn and binder materials, strand configurations, and/or mesh patterns of the scrim layers described herein may be configured to improve resistance to flame penetration and/or satisfaction of a flame penetration test of a corresponding flexible duct, while minimizing material and/or manufacturing costs.

The glass textile fiber yarn of the scrim layer 80 may include glass compositions known to those skilled in the art. For example, the glass textile fiber yarn may include A-glass fibers, C-glass fibers, D-glass fibers, E-glass fibers, Advantex® fibers (manufactured by Owens Corning®), ECR glass fibers, AR-glass fibers, R-glass fibers, S-glass fibers, T-glass fibers, S2-glss fibers, M-glass fibers, Z-glass fibers, or a combination thereof.

The filaments used in the glass textile fiber yarn of the scrim layer 80 may be continuous, stapled, texturized, or a combination thereof. The filaments used in the glass textile fiber yarn of the scrim layer 80 may have an average filament diameter in a range of 3 microns to 25 microns, such as, for example, about 4 microns, 4.5 microns, 5 microns, 6 microns, 7 microns, 8 microns, 9 microns, 10 microns, 11 microns, 12 microns, 13 microns, 14 microns, 15 microns, 16 microns, 17 microns, 18 microns, 19 microns, 20 microns, 21 microns, 22 microns, 23 microns, or about 24 microns. The filaments used in the glass textile fiber yarn of the scrim layer 80 may be twisted to form a strand. Further, one or more than one strand (e.g., 1 strand, 2 strands, 3 strands, 4 strands, etc.) may be twisted together to form the glass textile fiber yarn.

The glass textile fiber yarn may be configured into various mesh patterns to form the scrim layer 80. For example, FIG. 7A illustrates a scrim layer 80A configured in a tri-axial pattern with columns 82, first diagonal rows 86, and second diagonal rows 88. As another example, FIG. 7B illustrates a scrim layer 80B configured in a rectangular pattern with columns 82 and rows 84. As yet another example, FIG. 7C illustrates a scrim layer 80C configured in a square pattern with columns 82 and rows 84.

The columns 82 referenced above with respect to FIGS. 7A-7C may be spaced at a distance in a range of 0.2 cm to 10 cm, such as a distance of about 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, 2.0 cm, 2.5 cm, 3.0 cm, 3.5 cm, 4.0 cm, 4.5 cm, or about 5.0 cm. The rows 84 referenced above with respect to FIGS. 7B-7C may be spaced at a distance in a range of 0.2 cm to 10 cm, such as a distance of about 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, 2.0 cm, 2.5 cm, 3.0 cm, 3.5 cm, 4.0 cm, 4.5 cm, or about 5.0 cm. The first diagonal rows 86 referenced above with respect to FIG. 7A may be spaced at a distance in a range of 0.2 cm to 10 cm, such as a distance of about 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, 2.0 cm, 2.5 cm, 3.0 cm, 3.5 cm, 4.0 cm, 4.5 cm, or about 5.0 cm. The second diagonal rows 88 referenced above with respect to FIG. 7A may be spaced at a distance in a range of 0.2 cm to 10 cm, such as a distance of about 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, 2.0 cm, 2.5 cm, 3.0 cm, 3.5 cm, 4.0 cm, 4.5 cm, or about 5.0 cm.

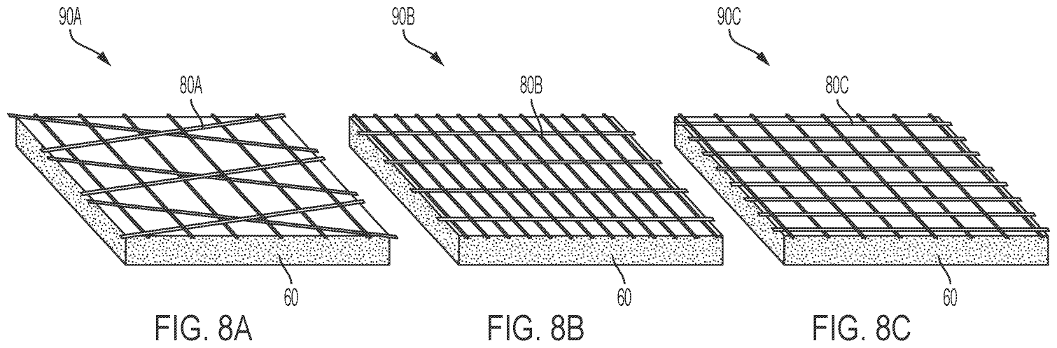

The insulation assembly 90 may be constructed by bonding the scrim layer 80 to the insulation layer 60. For example, FIGS. 8A-8C illustrate perspective views of insulation assemblies 90A-90C. Each of the insulation assemblies 90A-90C include a different scrim layer pattern (e.g., the scrim layer 80A, 80B, or 80C) bonded to the insulation layer 60. Any of the insulation assemblies 90A-90C may be used as the insulation assembly 90 of any of the flexible ducts 400, 500, 600, and 700 respectively shown in FIGS. 5, 6, 9, and 10.

Various techniques may be used to bond the scrim layer 80 to the insulation layer 60 to form the insulation assembly 90. For example, the scrim layer 80 can be bonded to fiberglass insulation material of the insulation layer 60 by applying an adhesive to a surface of the scrim layer 80 and/or a surface of the fiberglass insulation material and positioning the scrim layer 80 against the fiberglass insulation material. The adhesive used to bond the fiberglass insulation material and the scrim layer 80 may include various resinous and/or elastomeric binder materials such as, for example, acrylic binders, polyvinyl alcohol binders, polyvinyl acetate binders, phenol-formaldehyde binders, polycarboxy binders, polyurea binders and/or bio-based binders.

In another aspect of the present disclosure, the scrim layer 80 may be bonded to the insulation layer 60 during the manufacturing of the fiberglass insulation material. For example, fiberglass insulation material is typically manufactured by spinning molten glass through small holes to create glass fibers. Adhesive is applied (e.g., sprayed via spray nozzles) to the glass fibers to form a mass of adhesive-coated glass fibers. The mass of adhesive coated glass fibers are cured in a curing oven to form the fiberglass insulation material. The scrim layer 80 may be applied to the adhesive-coated mass of glass fibers prior to curing. Thus, the adhesive used to form the fiberglass insulation material may also be used to bond the scrim layer 80 to the fiberglass insulation material. The fibrous strands of the scrim layer 80 of FIGS. 5 and 6 may extend around the entire circumference of the flexible duct 400 with only a single seam. Accordingly, the scrim layer 80 may provide a more reliable resistance to flame penetration compared to the scrim layer 42.

The insulation assembly 90 can provide numerous benefits related to the manufacturing and performance of the flexible ducts described herein. In one aspect, the scrim layer 80 of the insulation assembly 90 may improve the resistance of the flexible duct 400, 500 to flame penetration by providing structural support to the flexible duct 400, 500. For example, the rate at which flame penetrates the flexible duct 400, 500 may depend on the structural properties of the flexible duct 400, 500. This may be because placing the various layers of the flexible duct 400, 500 under tension (e.g., by placing a weight on the body of the flexible duct 400, 500) may cause the layers to be more susceptible to flame penetration. The structural support provided by the scrim layer 80 may resist this tension force and therefore resist flame penetration of the flexible duct 400, 500.

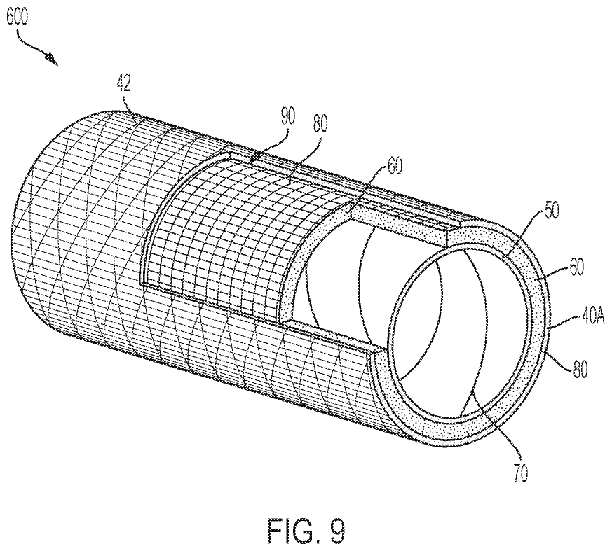

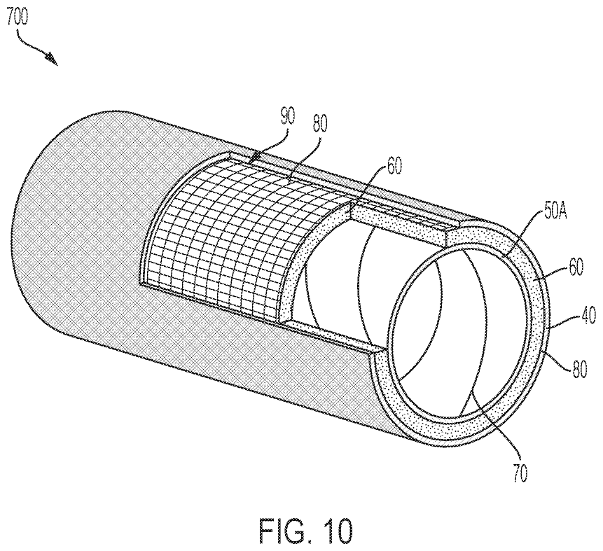

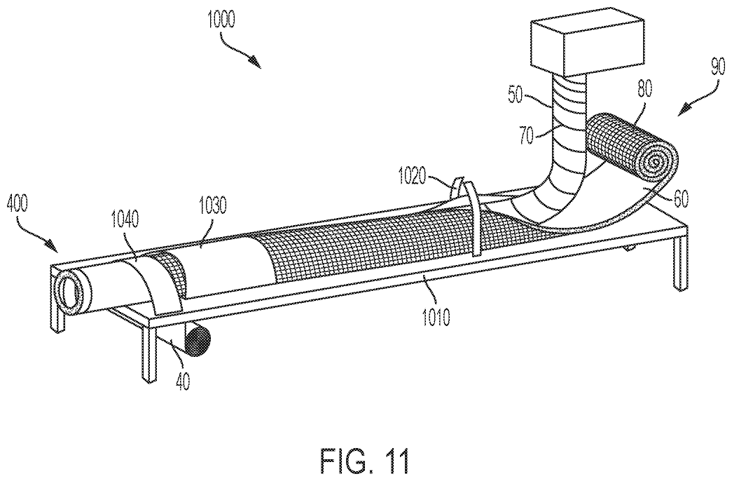

As another example, as explained in more detail below related to FIG. 11, the insulation assembly 90 may be easier to handle and incorporate into the flexible duct as a single layer during the manufacturing process compared to incorporating a separate scrim layer and insulation layer. Moreover, the scrim layer 80 may provide structural support to the insulation assembly 90 and reduce generation of waste that may occur when the insulation layer 60 tears during manufacturing of the flexible duct. As yet another example, as explained in more detail below with respect to FIGS. 9-10, the insulation assembly 90 may reduce and/or eliminate costs related to the scrim layer 42 described above with respect to FIG. 3 and/or the wire structure 52 described above with respect to FIG. 4.

FIG. 9 illustrates a partial cut-away perspective view of a flexible duct 600 configured to resist flame penetration. The flexible duct 600 is similar to the flexible duct 200 described above with respect to FIG. 3 except that the flexible duct 600 includes the insulation assembly 90. As explained above with respect to FIG. 3, the scrim layer 42 may be included in the vapor barrier 40A to provide structural support and improve the resistance of the flexible duct 200 to flame penetration. The insulation assembly 90 of the flexible duct 600 includes a scrim layer 80 that can similarly provide structural support and resistance to flame penetration. In some cases, because scrim layer 80 provides structural support to the flexible duct 600, the scrim layer 42 of the flexible duct 600 may not need to be as robust as the scrim layer 42 of the flexible duct 200 of FIG. 3 (e.g., because the flexible duct 600 includes both the scrim layer 80 and the scrim layer 42, the scrim layer 42 of the flexible duct 600 may not need to be as robust as the scrim layer 42 of the flexible duct 200). For example, the scrim layer 42 of the flexible duct 600 may be selected to provide enough structural support to reduce an occurrence of tearing of the vapor barrier 40A during the manufacturing, shipping, and/or installation of the flexible duct 600 but not necessarily to provide resistance to flame penetration. Accordingly, the scrim layer 42 of flexible duct 600 may be selected to include a less expensive glass textile fiber yarn material, configuration, and/or mesh pattern compared to the scrim layer 42 of flexible duct 200. Thus, implementing the insulation assembly 90 can reduce material costs related to the scrim layer 42.

As also explained above with respect to FIG. 3, the vapor barrier 40A may be helically wound into a tubular shape using a layered sheet of scrim and laminated film components having a width that is shorter than the outer circumference of assembled vapor barrier 40A. Accordingly, there may be interruptions in the scrim layer 42 around the circumference of the vapor barrier 40A where the seam(s) are located. Conversely, the fibrous strands of the scrim layer 80 of FIG. 9 may extend around the entire circumference of the flexible duct 600 with only a single seam. Accordingly, the scrim layer 80 may provide a more reliable resistance to flame penetration compared to the scrim layer 42.

FIG. 10 illustrates a partial cut-away perspective view of a flexible duct 700 configured to resist flame penetration. The flexible duct 700 is similar to the flexible duct 300 described above with respect to FIG. 4 except that the flexible duct 700 includes the insulation assembly 90. Further, unlike the flexible duct 300, the tubular core 50A of the flexible duct 700 may not include the wire structure 52 in order to achieve adequate resistance to flame penetration. For example, as explained above, the flexible duct 300 can include the wire structure 52 to provide structural support such that a scrim layer need not be included in the vapor barrier 40 for the flexible duct 300 to adequately resist flame penetration. In that case, the vapor barrier 40 of flexible duct 300 can be constructed from a blown polyethylene film. Returning to FIG. 10, the flexible duct 700 includes a scrim layer 80. The scrim layer 80 may include fibrous strands extending around the entire circumference of the flexible duct 700 with only a single seam. The scrim layer 80 provides structural support and resistance to flame penetration and may provide a more reliable resistance to flame penetration compared to the scrim layer 42. Thus, because scrim layer 80 provides structural support to the flexible duct 700, the flexible duct 700 may include a vapor barrier 40 constructed from a blown polyethylene film without including the wire structure 52 in tubular core 50A. Accordingly, the insulation assembly 90 of flexible duct 700 may reduce and/or eliminate material costs related to the wire structure 52.

FIG. 11 illustrates a schematic diagram of an apparatus 1000 for assembling a flexible duct. Although FIG. 11 shows a flexible duct 400 being assembled, the apparatus 1000 may be implemented to assemble any of the flexible ducts described herein. To assemble the flexible duct 400, a tubular core 50, an insulation assembly 90, and a vapor barrier 40 are provided. The tubular core 50, the insulation assembly 90, and the vapor barrier 40 may be positioned relative to a platform 1010. The platform may include a first collar 1020, a second collar 1030, and/or a third collar 1040. The first collar 1020 may include a pair of arms configured to position and/or wrap the insulation assembly 90 at least partially around the circumference of the tubular core 50. The second collar 1030 may have a tubular shape configured to position and/or wrap the insulation assembly 90 completely around the tubular core 50. Positioning the insulation assembly 90 relative to the platform 1010 such that the scrim layer 80 is facing away from the tubular core 50 will cause the scrim layer 80 to be adjacent to the vapor barrier 40 in the fully assembled flexible duct 400, as shown in FIG. 11. Positioning the insulation assembly 90 relative to the platform 1010 such that the scrim layer 80 is facing toward the tubular core 50 will cause the scrim layer 80 to be adjacent to the tubular core 50 in the fully assembled flexible duct, similar to the flexible duct 500 described above (not shown in FIG. 11).

The third collar 1040 can be configured to position and/or wrap the vapor barrier 40 at least partially around the insulation assembly 90. For example, as the insulation assembly 90 and the tubular core 50 are pulled across the platform 1010, the third collar 1040 can be used direct the vapor barrier 40 around the insulation assembly 90. Heat may be applied to the vapor barrier 40 to seal any seam that results from positioning the vapor barrier 40 around the insulation assembly 90. As can be appreciated from FIG. 11, the insulation assembly 90 can be more easily incorporated into the flexible duct 400 compared to introducing a loose scrim layer that is separate from the insulation layer 60. For example, incorporating a loose scrim layer requires the handling and insertion of an additional material stream. As another example, the scrim layer 80 may provide additional structural support to the insulation layer 60 to prevent or reduce an occurrence of the insulation layer 60 tearing as the insulation assembly is pulled across the platform 1010.

Further examples of the present disclosure may include:

Example 1 is flexible duct. The flexible duct includes a tubular core, a vapor barrier, and an insulation assembly. The tubular core is configured to convey a fluid. The vapor barrier surrounds the tubular core. The insulation assembly is positioned between the tubular core and the vapor barrier. Further, the insulation assembly includes an insulation layer and a scrim layer bonded to the insulation layer. The scrim layer is configured to resist flame penetration of the flexible duct.

In Example 2, the subject matter of Example 1 can further include wherein the scrim layer is bonded to a radially inward surface of the insulation layer.

In Example 3, the subject matter of Example 1 can further wherein the scrim layer is bonded to a radially outward surface of the insulation layer.

In Example 4, the subject matter of Examples 1-3 can further include wherein the scrim layer comprises a glass fiber textile yarn.

In Example 5, the subject matter of Examples 1˜4 can further include wherein the glass fiber textile yarn comprises E-glass fibers.

In Example 6, the subject matter of Examples 1-5 can further include wherein the scrim layer comprises at least one of tri-axial pattern, a rectangular patter, or a square pattern.

In Example 7, the subject matter of Examples 1-6 can further include wherein the insulation layer comprises a fiberglass insulation material.

In Example 8, the subject matter of Examples 1-7 can further include wherein the scrim layer is a first scrim layer, and wherein the vapor barrier comprises a second scrim layer.

In Example 9, the subject matter of Example 8 can further include wherein the vapor barrier further comprises a radially inward polyester film layer and a radially outward metallized polyester film layer surrounding the second scrim layer.

In Example 10, the subject matter of Examples 1-7 can further include wherein the vapor barrier comprises a blown polyethylene film.

Example 11 is an insulation assembly for use in a flexible duct. The insulation assembly can include a fiberglass insulation layer and a scrim layer bonded to the insulation layer. The scrim layer can be configured to resist flame penetration of the flexible duct when used in the flexible duct.

In Example 12, the subject matter of Example 11 can further include wherein the scrim layer comprises a glass fiber textile yarn.

In Example 13, the subject matter of Examples 11-12 can further include wherein the glass fiber textile yarn comprises E-glass fibers.

In Example 14, the subject matter of Examples 11-13 can further include wherein the scrim layer comprises at least one of tri-axial pattern, a rectangular patter, or a square pattern.

In Example 15, the subject matter of Examples 11-14 can further include wherein the insulation assembly is formed by spinning molten glass into glass fibers, applying adhesive to the glass fibers to form an adhesive-coated mass of glass fibers, applying the scrim layer to the adhesive-coated mass of glass fibers, and curing adhesive-coated mass of glass fibers.

In Example 16, the subject matter of Examples 11-14 can further include wherein the insulation assembly is formed by applying an adhesive to at least one of the scrim layer or the fiberglass insulation layer and placing the scrim layer against the fiberglass insulation layer.

Example 17 is a method for assembling a flexible duct. The method can include positioning an insulation assembly around a tubular core. The insulation assembly can include an insulation layer and a scrim layer bonded to the insulation layer. The method can further include positioning a vapor barrier around the insulation assembly to form the flexible duct. The scrim layer can be configured to improve a flame penetration resistance of the flexible duct.

In Example 18, the subject matter of Example 17 can further include wherein positioning the insulation assembly around the tubular core comprises positioning the scrim layer adjacent to the tubular core.

In Example 19, the subject matter of Example 17 can further include wherein positioning the insulation assembly around the tubular core comprises positioning the scrim layer adjacent to the vapor barrier.

In Example 20, the subject matter of Example 17-19 can further include wherein the insulation layer is a fiberglass insulation material. The method can further include assembling the insulation assembly. Assembling the insulation assembly can include spinning molten glass into glass fibers, applying adhesive to the glass fibers to form an adhesive-coated mass of glass fibers, applying the scrim layer to the adhesive-coated mass of glass fibers, and curing the adhesive-coated mass of glass fibers.

In Example 21, the subject matter of Examples 1-10 can further include wherein the scrim layer is configured to resist flame and weight penetration of the flexible duct when subjected to a flame penetration test according to Underwriters Laboratories (UL) test standard UL 181.

In Example 22, the subject matter of Examples 11-16 can further include wherein the scrim layer is configured to resist flame and weight penetration of the flexible duct when subjected to a flame penetration test according to Underwriters Laboratories (UL) test standard UL 181.

In Example 23, the subject matter of Examples 17-20 can further include wherein the scrim layer is configured to resist flame and weight penetration of the flexible duct when subjected to a flame penetration test according to Underwriters Laboratories (UL) test standard UL 181.

One or more specific embodiments of the flexible duct, scrim-bonded insulation, and related methods have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “embodiments,” “some embodiments,” “certain embodiments,” “aspects” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A flexible duct comprising:
a tubular core configured to convey a fluid;
a vapor barrier surrounding the tubular core; and
an insulation assembly positioned between the tubular core and the vapor barrier and surrounding the tubular core, the insulation assembly comprising:
an insulation layer; and
a scrim layer bonded to the insulation layer, wherein the scrim layer is configured to resist flame penetration of the flexible duct.

2. The flexible duct of claim 1, wherein the scrim layer is bonded to a radially inward surface of the insulation layer.

3. The flexible duct of claim 1, wherein the scrim layer is bonded to a radially outward surface of the insulation layer.

4. The flexible duct of claim 1, wherein the scrim layer comprises a glass fiber textile yarn.

5. The flexible duct of claim 4, wherein the glass fiber textile yarn comprises E-glass fibers.

6. The flexible duct of claim 4, wherein the scrim layer comprises at least one of tri-axial pattern, a rectangular patter, or a square pattern.

7. The flexible duct of claim 1, wherein the scrim layer is configured to resist flame and weight penetration of the flexible duct when subjected to a flame penetration test according to Underwriters Laboratories (UL) test standard UL 181.

8. The flexible duct of claim 1, wherein the scrim layer is a first scrim layer, and wherein the vapor barrier comprises a second scrim layer.

9. The flexible duct of claim 8, wherein the vapor barrier further comprises a radially inward polyester film layer and a radially outward metallized polyester film layer surrounding the second scrim layer.

10. The flexible duct of claim 1, wherein the vapor barrier comprises a blown polyethylene film.

11. An insulation assembly for use in a flexible duct, the insulation assembly comprising:
a fiberglass insulation layer; and
a scrim layer bonded to the fiberglass insulation layer, wherein the scrim layer is configured to resist flame penetration of the flexible duct when used in the flexible duct.

12. The flexible duct of claim 11, wherein the scrim layer comprises a glass fiber textile yarn.

13. The flexible duct of claim 11, wherein the scrim layer is configured to resist flame and weight penetration of the flexible duct when subjected to a flame penetration test according to Underwriters Laboratories (UL) test standard UL 181.

14. The flexible duct of claim 11, wherein the scrim layer comprises at least one of tri-axial pattern, a rectangular patter, or a square pattern.

15. The insulation assembly of claim 11, wherein the insulation assembly is formed by spinning molten glass into glass fibers, applying adhesive to the glass fibers to form an adhesive-coated mass of glass fibers, applying the scrim layer to the adhesive-coated mass of glass fibers, and curing adhesive-coated mass of glass fibers.

16. The insulation assembly of claim 11, wherein the insulation assembly is formed by applying an adhesive to at least one of the scrim layer or the fiberglass insulation layer and placing the scrim layer against the fiberglass insulation layer.

17. A method for assembling a flexible duct, the method comprising:
positioning an insulation assembly around a tubular core, the insulation assembly comprising an insulation layer and a scrim layer bonded to the insulation layer; and
positioning a vapor barrier around the insulation assembly to form the flexible duct, the scrim layer configured to improve a flame penetration resistance of the flexible duct.

18. The method of claim 17, wherein positioning the insulation assembly around the tubular core comprises positioning the scrim layer adjacent to the tubular core.

19. The method of claim 17, wherein positioning the insulation assembly around the tubular core comprises positioning the scrim layer adjacent to the vapor barrier.

20. The method of claim 17, wherein the insulation layer is a fiberglass insulation material, wherein the method further comprises assembling the insulation assembly, wherein assembling the insulation assembly comprises:
spinning molten glass into glass fibers;
applying adhesive to the glass fibers to form an adhesive-coated mass of glass fibers;
applying the scrim layer to the adhesive-coated mass of glass fibers; and
curing the adhesive-coated mass of glass fibers.
